(19) United States
(12) Patent Application Publication
(10) Pub. No.: US 2005/0161499 A1
(43) Pub. Date: Jul. 28, 2005

(54) Plant information system and method for a plant information system

(76) Inventors: Jurgen Bieber, Ettlingen (DE); Klaus Pechmann, Feucht (DE)

Correspondence Address: SIEMENS, 170 Wood Avenue, South, Iselin, NJ, 08830-9980, US

(21) Appl. No.: 11/039,596

(22) Filed: Jan. 20, 2005

(30) Foreign Application Priority Data
Jan. 20, 2004 (DE) 10 2004 003 052.9

(51) Int. Cl. G06F 7/00

(52) U.S. Cl. 235/376

(57) ABSTRACT

The present invention relates to a plant information system (1) with means (2) for acquiring a plurality of process information data (PI) from automation devices (5), systems (5), diagnostic devices (5), systems (5) and/or other devices (5) of a plant, and means 3b) for editing and/or presentation of the acquired process information data (PI). The plant information system (1) is characterized by means (1b) for selection, in accordance with criteria specified beforehand, of specific process information data from the plurality of process information data (PI). In this way, and with the corresponding inventive method, specific process information data from the plurality of acquired process information data (PI) which is of particular relevance for process execution or for a user can be selected, if necessary evaluated and displayed to the user.

### CROSS REFERENCE TO RELATED APPLICATIONS

This application claims priority to the German application No. 10 2004 003 052.9, filed Jan. 20, 2004 and which is incorporated by reference herein in its entirety.

### FIELD OF INVENTION

The present invention relates to a plant information system and method for a plant information system.

### BACKGROUND OF INVENTION

Ever more data is produced in modern production plant, especially in the process industry during the production process, caused by the increased use of intelligent field bus devices. Some of this data is used directly in systems for operation and monitoring (also HMI or SCADA systems) for the supervision and control of the relevant production process. Similarly data about the production process, but also from what are known as Historian Systems or Plant Information Management Systems (PIMS) is used so that the data is archived in high-performance databases and is subsequently available for analysis with the aid of statistical evaluation systems.

The systems currently employed for operation and monitoring (O&M systems) thus acquire process data in order to display the instantaneous values, for example in graphical form. In addition the O&M systems generate alarms and events from the data. They also archive the process variables where this is necessary for subsequent display. This archiving is typically undertaken in a proprietary form in a separate file system. The graphical representation of the process data can be undertaken on what are known as O&M clients. In such cases proprietary interfaces are used as a rule. It is above all important for O&M systems to be highly-available so as to ensure secure plant operation at all times. They therefore provide highly-developed redundancy mechanisms and allow functionality to be distributed, even over the Internet. In addition large systems for operation and monitoring are often distributed systems to enable the topology of the plant to be taken into account. This means that the recording of data as well as the derivations of messages and archiving is also distributed. However systems for operation and monitoring offer mechanisms the clients to make this distribution transparent.

The plant information systems currently employed in industry (Historian systems, PIMS) are used for the very rapid, central acquisition of process data. This process information data is stored as a rule in a database. The clients of these systems, for example simple database clients, can then interrogate and process this data later via standard interfaces (ODBC, OLE DB, ADO, SQL and such like).

In such cases the systems for operation and monitoring and also the historian systems often refer back to the same process information data. The as yet unpublished German patent application 10243065.9, written by the applicant, describes a system in which the functionality of both individual systems is combined into a single system. Combining the operation and monitoring functionality and the historian functionality of the two separate systems then avoids the duplication of effort usually required for acquiring and editing process information data. The same process information data does not have to be interrogated on a number of systems, but, once acquired, is then available for all further tasks, for example operation and monitoring or history functionality, centrally in the plant information system. However there will always be a few items of specific processing information data from all this acquired process information data which are especially relevant to normal operation, i.e. for process execution and for the plant users, and thus is to be made available separately to the user.

### SUMMARY OF INVENTION

The task of the present invention is now to provide a plant information system and a corresponding method which features expanded functionality in the acquisition and processing of the process information data.

This object is achieved by the claims.

The plant information system thus features means for acquiring a plurality of process information data of automation devices and systems, diagnostic devices and systems and/or further devices of a plant, and means for editing and/or presentation of the process information data acquired, and is characterized by means for selecting specific process information data from the plurality of process information data to be acquired in accordance with previously defined criteria.

Through these latter means for selection, individual-specific processing information data, that is data for the normal operation of the plant and especially for process execution, or also process information data important for the user and thereby relevant, is thus selected according to previously defined criteria from the plurality of process information data available in the plant. If this specific process information data is then displayed to the user, he now has the opportunity to obtain a rapid overview of the data.

This can be accordingly achieved with the method in accordance with the invention, where the method features the following steps:
Selection of specific process information data from a plurality of process information data to be acquired from automation devices, systems, diagnostic devices, systems and/or further devices of a plant in accordance with previously defined criteria,
Acquiring the process information data, and
Editing and/or displaying at least the selected specific process information data.

Since the specific process information data to be acquired is selected in the inventive plant information system as well as in the inventive method according to previously defined criteria, this relevant process information data can be acquired autonomously, that is independently of the user. Thus, especially during the operation of the automation system, the specific process information data, once defined in accordance with the previously defined criteria, is requested from the appropriate points in the production plant, i.e. acquired, stored and edited if necessary so that it can then be displayed to the user.

If the criteria can be defined on a user-specific basis, the user has the opportunity to select specific process information data which is of significance to him. Thus, prior to actual process execution, meaning for example at the project planning (engineering) stage or before the plant is put into operation, but also during process operation (runtime) the user can define which specific process information data acquired, collected and where necessary also edited for him during normal operation of the plant is to be displayed to him during process execution.

The criteria for the acquisition of specific process information data which is of importance for smooth operation of the system should on the other hand have been defined process-specifically during the engineering phase of the plant. It is thus possible to ensure that this process information data specifically relevant to the process concerned can also be displayed to the user. As a rule the specific process information data to be acquired is selected by a combination of defined user-specific and process-specific criteria.

Depending on the type of plant and the production processes that it implements, it can be necessary for the acquisition and if necessary the editing of specific process information data to be undertaken in repeating cycles, whereas the acquisition and editing of other specific process information data is event-driven. Thus process information data which points to a fault is correspondingly event-driven, meaning that it is acquired immediately after the fault occurs, so that it can then also be displayed to the user immediately. Other relevant process information data, for example process temperature or pressure, etc. can on the other hand be acquired in repeated cycles, meaning in specific timing states.

In order to present the acquired and edited selected specific process information data to the user for display, this is to be forwarded in an appropriate way to a previously configured receiver. In the inventive plant information the appropriate communication means for doing this are provided, which in particular forward the edited selected specific process information data to the configured receiver. This means that a user can interrogate the selected specific process information directly via this configured receiver to obtain an overview of the current process state of the system.

The edited, selected specific process information can in such cases be forwarded in repeating cycles or on an event-driven basis. Thus, especially when the user is connected to the plant online via the receiver, the current values of the selected process information data can be presented to the user for display is repeated cycles. The user thus obtains an ongoing overview of the specific process information data. On the other hand the selected process information data can also be displayed to users on an event-driven basis, for example as soon as they log into the system. This means that users obtain a rapid overview of the selected specific process information data at the point at which they log back into the system, for the purposes of operation and maintenance for example.

The specific process information data can be displayed directly with corresponding means for operating and monitoring the plant information and/or are displayed on the clients connected to the plant information system. Preferably at least the specific process information data is forwarded to the previously configured recipient in SMS, e-mail or a fax format to the previously configured receiver. Thus the user, at the very time that plants are becoming increasingly decentralized with their devices and systems geographically widely dispersed and interconnected over a wired or wireless network, for example the Intranet or a Web such as the Internet, has the opportunity of obtaining the selected specific process information data which is relevant to him at a previously configured receiver. In particular this provides the option of being able to display the specific process information data and its evaluation directly at a wireless receiver, for example a mobile radio device or a DECT telephone which has been previously configured as a receiver. The user thus has the opportunity of obtaining the relevant process information data even when not in the vicinity of the plant.

The criteria for the selection can be defined in the simplest way using entry means embodied as components of what is known as a software agent. In these components, the corresponding rules can be defined or the corresponding filter functions selected in the simplest way, especially by the user, with which the criteria for the selection of the process information data to be acquired can be defined.

The method in accordance with the invention is executed in particular by a computer program product.

### BRIEF DESCRIPTION OF THE DRAWING

The invention is described and explained in more detail below on the basis of the exemplary embodiment shown in the sole FIGURE:

FIG. 1 shows a plant information system connected to various clients and the devices of a plant for executing a production process.

### DETAILED DESCRIPTION OF INVENTION

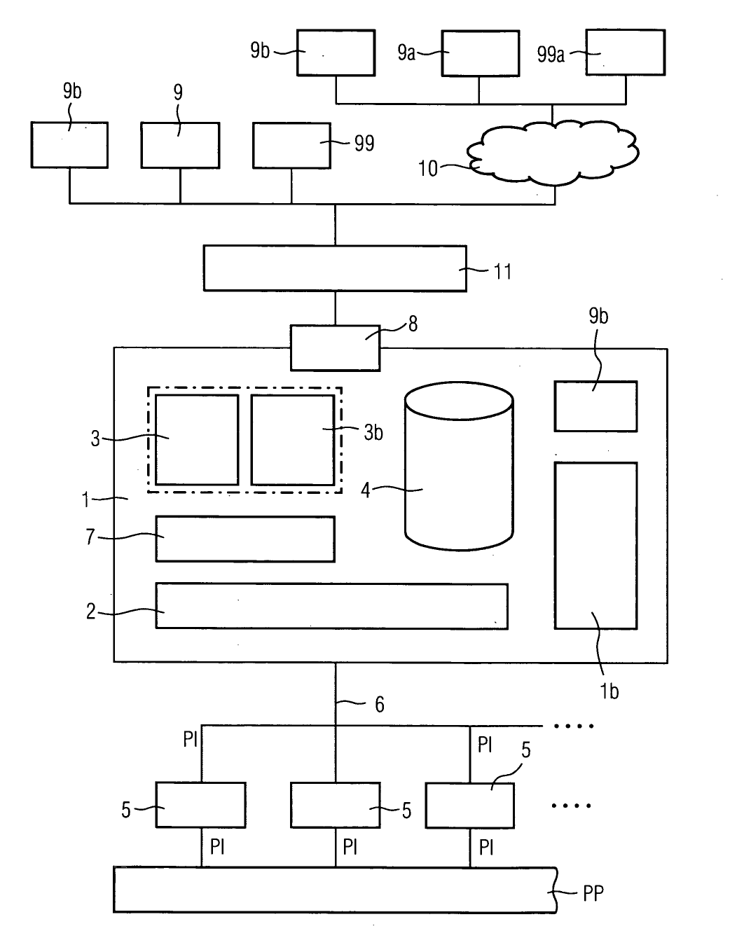

The plant information system 1 acquires a plurality of process information data PI from a production process PP of the plant. The process information data PI stems from automation devices, systems, diagnostic devices, systems and/or further terminals which are all referenced by the number 5 in FIG. 1. The process information data PI is transmitted to the system 1 via a data transmission device 6. The data transmission device 6 can for example be a bus system. In particular the data is acquired by the means 2 and edited for real-time provision for use in the system 1. Optionally a device 3 for editing or display of the acquired process information data PI can be present in the system 1. Furthermore a database system 4 for archiving the acquired process information data PI can be provided. The database 4 can be an SQL server in this case. The process information data can be used by further means 7 for generating alarms or events. The plant information system 1 can communicate with a wide diversity of clients 9, 9a, 99, 99a via an interface 8 which is embodied as a communication means. Communication here can be via the Internet 10. A multiplexer 11 can be provided for cover for redundancy and/or a number of data servers.

In the exemplary embodiment of the invention shown in the FIGURE the process data PI which is obtained by automation devices 5 or diagnostic devices 5 at a production process PP can be forwarded directly to the plant information system 1. In addition to bus systems any type of communication networks can be used as the data transmission device 6, such transmission over an Internet for example. The process information data PI is used by system 1 for operation and supervision in order to represent the current plant status for an application. As a rule a user can also influence the corresponding production process PP via the system 1, in that the data transmission device 6 can be used to address the controllers. For example it is conceivable for required values to be set in this way. Similarly for example influence can be exerted via the operation and supervision system 1 on the feed quantities of various basic substances which are used in the production process.

To draw the user's attention to specific situations the plant information system 1 is able to generate alarms or even events on the basis of the process parameters PP acquired. The simplest analyses of the process parameters are thus possible through the means 7 for generating the alarms and events.

A comprehensive analysis of production processes over a longer period is also made possible by the system 1 in that the process information data PI is archived within the plant information system 1 on a database 4. All the measured values taken from the production process are stored on the database 4. The operation and supervision system 3 thus enables fast access to be provided at all times to the historical process information data which describes a production process PP even over a longer period. This allows an analysis, for example a comparison between different batches of a production process, to be undertaken using the plant information system 1.

The process information data PI acquired from the automation devices or diagnostic devices 5 PI can thus be used by the system 1 both to display the current plant status and also for archiving for the purposes of a subsequent more precise analysis. In particular the data for both functionalities also only needs to be obtained once.

Proprietary clients 9, for example specific clients for operation and supervision, such as SCADA clients or also Web-capable clients 9a, for example a Web navigator for a system for operation and supervision, can be connected as communication resources via a suitable interface 8 to the plant information system 1. Independent clients 99, 99a, which themselves provide specific functionality, but are not directly equipped with functionality for operation and supervision, can be connected to the system 1 via the interface 8 and can refer back to process information data PI. Thus even the process information data archived in the database can for example be displayed and further processed on specific analysis clients possessing specific evaluation, analysis, statistics and graphics functionality.

Likewise standard programs, for example a Microsoft Office environment, can be used. Worldwide information about the current state of the plant as well as about the plant history in relation to the production process is thus possible at all times. The information can in such cases be accessed either via the proprietary B&B interface, or also through remoting of the corresponding generic database interfaces

Overall this plant information system 1 allows any type of access at any time from any location via a very wide variety of clients 9, 9a, 99, 99a to the process information data PI of a plant, for both operation and supervision (B&B functionality) of the plant and for historian functionality. In accordance with the invention this plant information system is also expanded to the extent that it allows a number of items of specific process information data to be selected from the large volume of acquired process information data PI which are relevant for smooth process execution relevant and are thus to be displayed separately to the user (agent functionality).

This involves expanding said described plant information system 1 with components of what is known as a software agent, basically constructed in a similar way to a scheduler.

In the exemplary embodiment shown in FIG. 1 the software agent is divided into three components. One component 9b here implements the input means 9b, a second component 1b implements the means for selecting specific process information data and a third component 3b implements the means for editing this specific process information data. In such a system the input means 9b, as can be seen from FIG. 1, can be incorporated directly into the plant information system 1 or can be embodied as a client. The means for selection 1b can acquire process information data directly via means 2 from the various terminals and systems 5 of the plant or interrogate acquired process information data PI stored in the database 4. The means for editing 3b are used primarily for graphical editing of the specific process information data and can be embodied as parts of the means 3 or also independently of these means 3.

In accordance with the invention, the method for selecting specific process information data from the plurality of acquired process information data to be displayed to the user is executed in the following steps.

So that specific process information data can be selected from a plurality of process information data PI to be acquired from automation devices 5, systems 5, diagnostic devices 5, systems 5 and/or further devices 5 of a plant, the appropriate criteria for the selection must be acquired beforehand. This can be done using the corresponding input means 9b, for example a so-called software agent configurator. In the software agent configurator 9b for example, at the time that the plant is engineered, the criteria are defined for the specific process information to be acquired, its reference sources, the logical and arithmetic links, the type of triggering for acquisition and forwarding, meaning which process information data is to be acquired and when it is to be acquired and via which communication paths it is to be forwarded to which receiver. These settings of the criteria can be changed or new ones entered in the software agent configurator but also in runtime operation (process operation).

This configuration data, meaning in particular the criteria defined for selection of specific process information data is then transferred to a further control software agent, known as the control software agent, or this fetches the configuration data at the start of the runtime system. Based on these criteria the corresponding process information data PI is then acquired and the specific process information data selected. To do this these components communicate with the underlying data sources 5, or also the databases 4 and on the basis of the criteria created with the software agent configurator, they collect the corresponding process information data. In this case the Runtime software can either first acquire all process information data, and only then make a selection of the specific process information data, or it can acquire the specific process data selectively in advance. The sequence of acquisition is rather less important provided that, at the end, the specific process information data selected in accordance with the criteria configured beforehand is available for forwarding to the user.

This specific process information data acquired from the Runtime software agent is then transferred to a further software agent component, known as the process visualization software agent 3b. This component has the task of editing the data graphically and transferring it to the corresponding configured receiver. These can be either the connected clients 9, 9a, 99, 99a or also other configured receivers, for example mobile communication receivers, or also the control visualization component software agent itself. These receivers must naturally be embodied so that the forwarded edited can be displayed to a user.

The incorporation of a software agent into the area of the plant information system is based on the idea that users in particular, using evaluation rules and filters set in the software agent configurator, can collect, concentrate, aggregate and compress specific process information data in order to display this edited data to the user on corresponding configured receivers.

The software agent in this case is constructed in such a way as to enable the user to log out of the system 1 and the personal (user-specific) or the role-based (process-specific) software agent to continue independently with the processing of the previously configured operating steps, meaning that it collects the specific process information data, assembles it accordingly and forwards to the receiver configured for the user. In particular the software agent can contact the user via SMS, e-mail, fax or also be telephone in order to inform the user, even when he is logged out, about the status or the results of the software agent task. If the user logs into system 1 he can immediately obtain the information that he requires which the software agent has obtained an evaluated overnight for example. The power of this service of a software agent is determined here by the software agent configurator since this defined the functional scope of the agent task. The Runtime software agent is then nothing other than a control software component which executes the task according to these prepared rules, obtains the corresponding process information data and makes it available to the user.

Thus for example complex calculations or analyses of specific process information data can be undertaken automatically, independent of the user or also time-triggered agent jobs, e.g. if a specific process event occurs, can be started, regardless of whether the user is working at the system or not. It is precisely in complex plants that a plurality of data and jobs arise which can be handled by such control agents integrated into a plant information system.

1.-15. (canceled)

16. A plant information system, comprising:
a mechanism for acquiring a plurality of process information data (PI) from automation devices, automation systems, diagnostic devices, diagnostic systems and/or further devices of a plant;
a mechanism for preprocessing and/or presentation of the acquired process information data; and
a mechanism for selecting specific process information data from the plurality of process information data acquired in accordance with previously defined criteria.

17. The system in accordance with claim 16, further comprising an input mechanism for defining the criteria according to specific users and/or specific processes.

18. The system in accordance with claim 16, wherein the acquisition and editing of the selected specific process information data is repeated in cycles and/or event-driven.

19. The system in accordance with claim 17, wherein the acquisition and editing of the selected specific process information data is repeated in cycles and/or event-driven.

20. The system in accordance with claim 16, further comprising communication mechanisms for forwarding the acquired and the preprocessed selected specific process information data to at least one previously configured receiver.

21. The system in accordance with claim 17, further comprising communication mechanisms for forwarding the acquired and the preprocessed selected specific process information data to at least one previously configured receiver.

22. The system in accordance with claim 18, further comprising communication mechanisms for forwarding the acquired and the preprocessed selected specific process information data to at least one previously configured receiver.

23. The system in accordance with claim 20, wherein the forwarding is repeated in cycles and/or event-driven.

24. The system in accordance with claim 20, wherein the communication mechanisms are adapted to forward at least the preprocessed selected specific process information data in the format of an SMS, an e-mail, and/or a fax to the receiver.

25. The system in accordance with claim 23, wherein the communication mechanisms are adapted to forward at least the preprocessed selected specific process information data in the format of an SMS, an e-mail, and/or a fax to the receiver.

26. The system in accordance with claim 17, wherein the mechanism for preprocessing, the mechanism for selecting and the input mechanism are components of a control agent and the criteria for selecting of the user can be defined in the input mechanism by rules and/or filter functions.

27. A method for operating a plant information system, comprising:
selecting specific process information data from a plurality of process information data to be acquired from automation devices, automation systems, diagnostic devices, diagnostic systems, and/or further devices of a plant in accordance with previously defined criteria;
acquiring the process information data; and
editing and/or displaying at least the selected specific process information data.

28. The method in accordance with claim 27, further comprising defining the criteria for specific users and/or specific processes.

29. The method in accordance with claim 27, wherein the acquiring and editing of the selected specific process information data is repeated in cycles and/or event-driven.

30. The method in accordance with claim 27, further comprising forwarding the acquired and the edited selected specific process information data to at least one previously configured receiver.

31. The method in accordance with claim 30, wherein the forwarding is repeated in cycles and/or event-driven.

32. The method in accordance with claim 30, wherein at least the edited selected specific process information data is forwarded in SMS, e-mail, and/or a fax format.

33. The method in accordance with claim 31, wherein at least the edited selected specific process information data is forwarded in SMS, e-mail, and/or a fax format.

34. The method in accordance with claim 27, further comprising defining the criteria for selecting by rules and/or filter functions.

35. The method in accordance with claim 27, wherein the method is performed by a computer program product comprising program mechanisms for executing the method on a processor.
